(19) United States
(12) Patent Application Publication
(10) Pub. No.: US 2017/0051808 A1
(43) Pub. Date: Feb. 23, 2017

(54) Smart Springs and their Combinations

(71) Applicants: Philip Bogrash, Ashdod (IL); Roger Bogrash, Ashdod (IL)

(72) Inventors: Philip Bogrash, Ashdod (IL); Roger Bogrash, Ashdod (IL)

(21) Appl. No.: 15/307,818

(22) PCT Filed: Apr. 30, 2015
(86) PCT No.: PCT/IL2015/000021

§ 371 Date: Oct. 29, 2016

Related U.S. Application Data
(60) Provisional application No. 61/986,292, filed on Apr. 30, 2014.
(60) Provisional application No. 62/007,498, filed on Jun. 4, 2014.

(51) Int. Cl. F16F 9/44; F16F 1/36; F16F 9/10; F16F 1/22

(52) U.S. Cl. CPC F16F 9/44; F16F 1/22; F16F 1/3615; F16F 9/10; F16F 2228/066

(57) ABSTRACT

Springs of different types are provided with the ability to dynamically change stiffness. For one embodiment turning the elastic beams with elongated cross-section inside a leaf spring's housing plate, leaf springs stiffness is varied. Friction forces between plates are also controlled by using a thin layer of electro-rheological fluid between plates whose viscosity is greatly varied by application of voltage. Second embodiment springs made of hollow tubing filled with oil wherein inside pressure is changed by an actuated membrane or piston whose movement drastically increases the hydrostatic pressure inside the tubing and thus increases tensile stress in the tubing's wall and expands the diameter of tubing which may be of cross-section purposely suited for expansion, thereby increasing its stiffness or decreasing it with any desired frequency or changing the stiffness possibly in milliseconds for a period of time. These springs that are also provided with limited actuation capability are especially suitable for counteracting vibration when changing stiffness with same frequency as vibration. When a number of such springs are used to support one load, they can be used for dynamically varying the load distribution or preventing a change to said load distribution in real time. Another embodiment features annular corrugated tubing which with the increase in inside pressure will substantially lengthen, producing large coil radius expansion and accordingly large decrease in spring stiffness, still another embodiment uses corrugated tubing inside a retaining cylinder; said tubing expands lengthwise when inside pressure is increasing but retaining cylinder forces the lengthening tubing to produce new coils inside of it resulting in spring length increase that is actuation and large stiffness variability resulting from coil number variability.

### RELATIONSHIP TO OTHER APPLICATIONS

The present patent application is related pursuant to the concept of the unity of an invention to our provisional patent applications 61/940,630, provisional patent application 61/986,292 and provisional patent application 62/007,498 and claims benefit of the filing date of said provisional application 61/986,292.

### 1. FIELD OF THE INVENTION

This invention relates to springs of various functions and types provided with the ability to change their stiffness dynamically in real time or by manual adjustment and also optionally having the actuation capability.

### 2. DESCRIPTION OF THE PRIOR ART

There is a number of types of springs existing today which serve different functions, most common of them were invented several centuries ago and changed little since then. Most springs in normal operation change the force that they produce, in reaction to being either compressed or extended, linearly in proportion to the extent of their deformation and the spring Rate which is alternatively known as the “Spring Constant”. The U.S. Pat. No. 8,448,962 presents an example of a helical spring which features restraining elements applied to the spring to immobilize a number of coils in it. Thus the shortened active part of the spring is rendered stiffer. That system also features a motor with a controller to move the said restraining elements. That system is rather complicated mechanically which unavoidably substantially increases its cost and decreases reliability, it limits the amount of movement that the remaining active part of the spring can do and therefore the range of stiffness variability is limited as the spring has to have movement. It certainly cannot change the spring stiffness dynamically or in real time. Finally this approach is only applicable to the helical springs and cannot be used for the springs of all the other types. There are other patents trying to develop this principle of limiting and varying the number of active coils in a helical spring while immobilizing the rest of them, but all those designs suffer from the same shortcomings, limitations and deficiencies.

Another approach for varying the stiffness is well known in the art for a very long time; it comprises a disk pressing on the end coils which are closed and ground to a flat plane. The spring is pre-compressed and thus is made stiffer. All the shortcomings and limitations described for the former design apply to the latter. The application PCT/162010/054846 describes a combination of the former and latter approaches; it features instead of a flat disk, a leading element with helical grooving which screws onto the end of the spring thus immobilizing the coils which enter it, while compressing the remaining active part of the spring. Once again this design suffers from the same list of shortcomings, limitations and deficiencies, as it is based on the same deficient concepts.

There is nothing in the prior art related to the spring having the capability of acting as an actuator or being able to act as a sensor providing a direct signal to the control system when measuring the force acting on said spring and its deformation. In light of the foregoing we conclude that the prior art and its underlying concepts are clearly inadequate.

### 3. OBJECTS AND ADVANTAGES

One object of the present invention is to provide a spring with the ability of the dynamic adjustment, possibly according to a predetermined mathematical function or formula, of the spring Rate and therefore of the said spring stiffness by the control system depending on the operating conditions or requirements.

Another object is to be able to change the spring Rate and therefore its stiffness nearly instantly by the control system command or by a person either manually or remotely by means of an operator command.

Another object is to provide the spring the ability to change its stiffness and optionally its length with the required frequency and phase in order to be able to counteract or mitigate the effects of a vibration affecting the spring and the load that it bears.

Another object is to be able to dynamically or manually control the stiffness of a number of springs, each bearing a part of one load, differentially in order to be able to control and determine the distribution of said load or to prevent the change in the load distribution.

Another object is to be able to control and almost instantly adjust the friction forces acting within the spring assemblies such as for example the leaf spring stacks.

Another object is to provide a spring with the ability to change its stiffness with the required frequency to counteract or mitigate vibration in the context of a larger overall increase or decrease in stiffness required for other purposes.

Another object is to provide the spring with the ability to expand or contract lengthwise in conjunction with it varying its stiffness thereby providing it with the actuation capability.

Another object is to provide the spring itself with the ability to act as a sensor measuring the force acting on it and its resulting deformation without needing any dedicated sensors for that purpose.

### 4. BRIEF DESCRIPTION OF THE DRAWINGS

FIG. 1 illustrates the change in the area moment of inertia of a rectangular beam when its profile is turned relative to the horizontal axis

FIG. 2 is a top view a housing plate of a leaf spring which comprises turnable elastic beams.

FIG. 3 is a top view of a torsion comprising turnable elastic beans.

FIG. 4 is a partial view of the hollow tubing spring comprising an actuator with a membrane assembly

FIG. 5 is a view of a cross-section of of hollow tubing with the radial expansion capability.

FIG. 6 is a view of a cross-section of hollow tubing with a Smart Memory Alloy active element mounted inside of it.

FIG. 7 shows a side view of hollow tubing with a Smart Memory Alloy active element mounted inside of it.

FIG. 8 is a view of a cross-section of hollow tubing having a structure likely to be deformed by torsional stress with a diagram or torsional deformation superposed on it.

FIG. 9 shows a partial view of tubing having profile with ridges twisted thread-like.

FIG. 10 is a partial view of annual corrugated tubing comprising a coiled spring.

FIG. 11 shows a coiled spring comprised of expandable lengthwise corrugated tubing enclosed in a retaining cylinder and able to vary the number of coils in it.

### 5. DESCRIPTION OF PREFERRED EMBODIMENTS

It is known that the bending stiffness of a beam is proportional to its cross-section's area moment of inertia. For example said moment of inertia for a beam with a rectangular cross-section

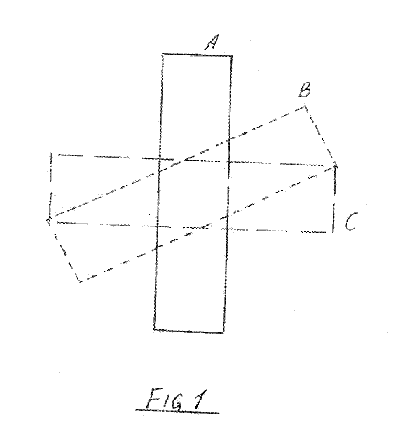

(FIG. 1, a) is: lx=b h3/12 where h is the height of the profile and b is its width From this formula it is clear that the area moment of inertia and therefore the stiffness of this beam is far greater relative to the horizontal axis X than it is relative to the vertical axis Y. Thus turning this beam by 90 degrees will result in the drastic decrease in its stiffness (FIG. 1, c). If however for example this beam is turned by less than 90 degrees into an intermediate position as shown on (FIG. 1, b), its area moment of inertia will be of intermediate value−less than the one shown on (FIG. 1,a) and greater than the one shown on (FIG. 1, c). Thus it is clear that by means of turning a beam we can vary the value of its pertinent area moment of inertia and therefore its stiffness. However if the beam shape is not rectangular but rather is of purposely selected rounded shape such as for example an oval or an ellipse, such area momentum of inertia's change will be smoothed. Furthermore other beams of predetermined cross-sectional shapes can be provided, so that turning them will change their pertinent area moment of inertia's value relative to the intended coordinate axis and thus the beam's stiffness according to a desired mathematical function; such as for example linear or sinusoidal or according to a more complex mathematical formula if needed.

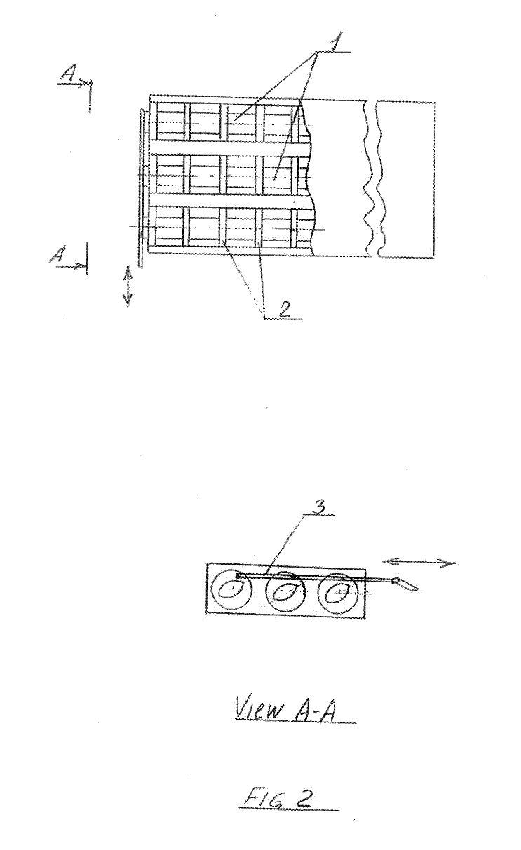

First embodiment of this invention (FIG. 2) will comprise elastic element(s); consisting of a beam of a suitable cross-sectional shape (1) upon which are mounted support cylinders or disks or a predetermined number of sectors/segments of disks or cylinders (2) at a predetermined distances from each other. For a leaf spring version of this embodiment these assemblies are inserted into a suitable round flexible holding tubes bracketed together in a row or other suitable pattern or another type of a suitably stiff, but flexible housing with cylindrical holes of a diameter into which the said assembly(s) will closely fit and be able to turn. Lubrication can also be provided for easy and smooth turning of the support cylinders or disks or sectors/segments thereof. At least one of these beams' ends will be operatively connected to a turn actuator and the other beams will be mechanically linked to it, for example the same type of linkage (3) as the wheels of a steam locomotive are linked or the beams' ends will have gear sectors which are in mesh with the rack linked to a linear actuator or a manually movable lever for turning the beams. If necessary, in order to cancel out the lateral forces produced by the application of force to the leaf spring and accordingly to its beams, they may be turned in opposite directions by the same angle, such as for example all even numbered beams would be turned clockwise while the odd numbered beams are turned counterclockwise or vice versa. Two links or racks of the kinds described above operatively connected to the beams and to the linear actuators in an appropriate manner depending on whether they are even or odd numbered will then be required or the beams may be turned by the miniature actuators individually.

However the leaf springs typically comprise a stack of flat spring plates of diminishing from the base lengths; this stack of plates ads rigidity to the overall leaf spring assembly and produces friction between the flat spring plates to help suppress excessive spring oscillations. For the leaf spring of the present invention the larger flat spring plates will be produced to incorporate the turnable beams and the beams turning can be synchronized either by means of electrically synchronizing their individual miniature actuators or mechanically, for example by a toothed belt in mesh with all of the beams' gear sectors and one main turn actuator.

To control the friction forces between the flat spring plates at least a part of their surfaces or of surface cover parts can be provided with parallel grained or cross grained areas or other such roughened areas for better traction and a thin layer of electro-rheological fluid placed between the pressed against each other, roughened areas of the surfaces delimited by the suitable gaskets to keep the said fluid in, with a connection to the voltage source provided for the parts of spring plates thus matched over the layer of said fluid, with suitable insulation where appropriate to prevent the undesirable currents.

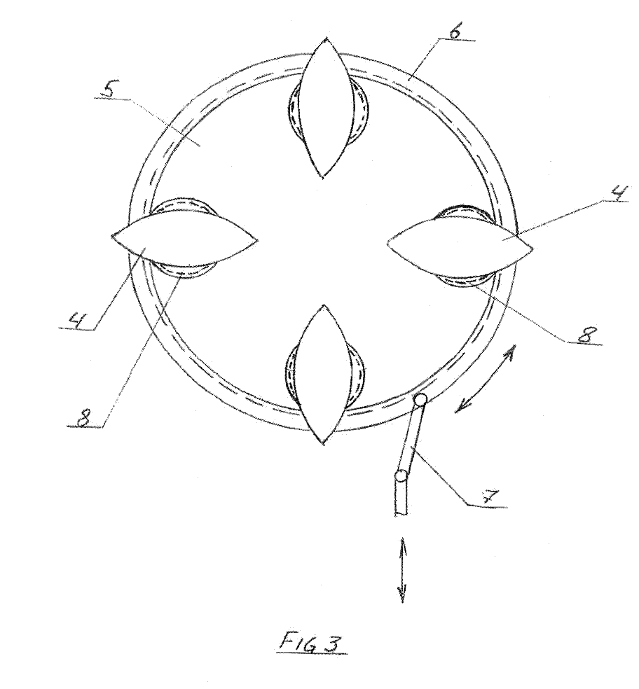

The torsion spring (FIG. 3) will be implemented by having the beams (4) turnably fitted into the bases (5) at both of their ends forming a circle. On one end the beams will be linked to a control ring (6). Said control ring will be turnably mounted on the base and operatively connected via linkage (7) to a linear actuator. It will be in mesh with gears (8) of each beam at its base. The other ends of these beams (4) will be turnably fitted into the load base (not shown) where the torque workloads will be applied to it by known means. Alternatively the control ring can be made toothed on the outside as well and in mesh with a pinion mounted on a turn actuator's shaft. Where appropriate the springs of this embodiment may be provided with the known locking mechanisms to assure that the elastic beams stay in position until a change in their position is required.

The straight beams present in this embodiment cannot be used to produce a coiled helical spring, however flat, triangular coil, rectangular coil etc springs can be produced using these turnable beams and the angular joins, wherein the beams' ends inserted into said joins will have gear sectors which will be in mesh to transfer the turning motion or other known means to transfer said motion. Either the first or the last beam's end will be operatively connected either to an actuator or a manual lever to turn it and all the other connected beams. The stiffness variability for these spring structures will arise from them being subjected to bending stresses in addition to the usual torsional stresses found in the round coiled springs.

The advantage of this embodiment is the broad range of stiffness variability from fairly flexible to nearly rigid.

Second embodiment of the present invention is suitable for a number of spring types. The helical spring can be implemented by using not the solid metal or other solid elastic material coiled wire, but of hollow coiled tubing made of the same or similar materials as the known springs that they are intended to replace.

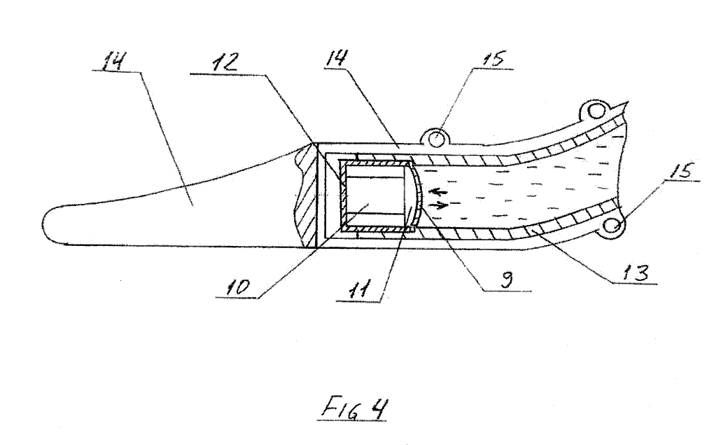

The hollow tubing will be fully filled with an incompressible liquid (FIG. 4) such as mineral oil with no air pockets and hermetically closed at both ends. Under certain circumstances it may be desirable to fill said tubing with a compressible liquid as described in more detail below. On one end the liquid will be faced by a membrane (9) made of suitable material able to withstand high pressures, behind which and operatively connected to it, will be a miniature, where appropriate, actuator (10) such as smart memory alloy actuator, piezo-electric crystal stack/actuator or other suitable types of actuators. It will press a rounded head (11) against the membrane or otherwise be operatively connected to it in order to be able to apply force to the membrane.

Alternatively the actuator could be coupled with a piston, instead of said flexible membrane, movable more or less into the tubing's hollow through a suitable gasket.

The actuator/membrane assembly may be housed inside a cartridge (12) inserted for example by a temperature fit into the broached end of the spring tubing (13). The end of tubing with said cartridge (12) will be placed into an end of spring shoe (14) where screw holes (15) are for the screws attaching the cover to the said shoe thus fixing the tubing's end inside said shoe (14) This is just one example of how the membrane and the miniature actuator can be placed at one end of the tubing. Alternatively the cartridge (12) containing the actuator/membrane assembly can be inserted lightly fixed or even loosely into the tubing with both ends of said tubing hermetically sealed, with wires for the actuator passed through one of said sealed tubing ends. For some tubing shapes and materials such as the plastic springs, especially with non-round hollow part of the cross-section, some change in the volume of the tubing's hollow can be expected when the spring is compressed or extended and for those cases it would be better if the membrane or piston was larger than the inside diameter of the tubing with the larger volume of liquid in front of it and more of a volume which could be vacated by the retracting membrane or piston. That situation would necessitate placing the larger membrane or piston outside of the spring's tubing while connected to it, for example by a piece of a tubing or hose coming out of the sealed end of tubing or from a hole made on the side of the end coil etc, and either inside or outside of the spring coils perimeter or connecting as described above the spring to a hydraulic high pressure line or circuit. Optionally the spring of this embodiment can be initially manufactured with an elevated pressure inside the hollow which will necessitate the actuator header locked in a neutral position in order to keep either the membrane or the piston in a neutral position corresponding to the spring's original stiffness. An actuator with a lock or a separate known locking mechanism will be required for keeping the actuator and accordingly the membrane or piston in a given position, whether neutral or otherwise. Another possibility will be to use a manually turnable screw instead of an actuator which would be particularly suitable for the applications where the springs may be used without access to the electricity such as for example the bicycle suspension springs.

In the second version of this embodiment the hollow tubes will be filled with a flexible electric heating cord will run through the tubing and both ends of the spring's tubing will be hermetically sealed.

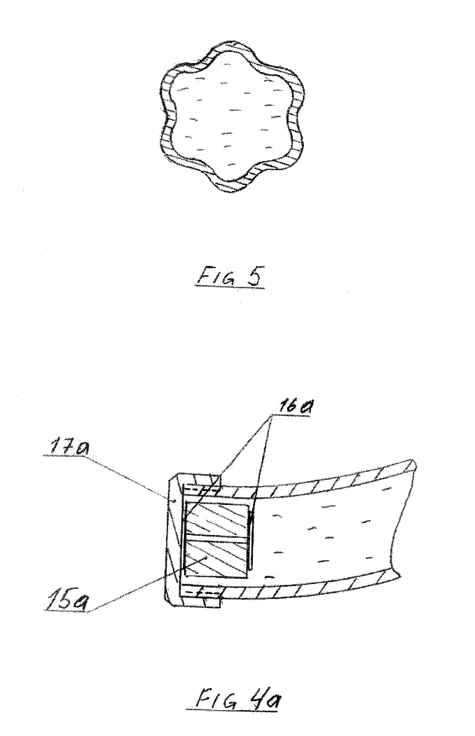

In order to further increase the stiffness of the spring when the internal pressure is applied a third version of this embodiment will feature a non-round cross-sectional shape such as shown on the (FIG. 5) that has ridges and channels which will expand and eventually approximate the round shape with the increase in internal pressure inside the tubing's hollow. Such cross-sectional shape expansion will cause the increase of said cross-section's polar moment of inertia which is a known major factor determining the stiffness of a coiled spring. That expansion would also cause the increase in the area moment of inertia of said cross-section which is a known major factor determining the bending stiffness which is relevant when the tubing assembly of this version of the second embodiment is used as a non-turnable elastic beam within a leaf spring's plate which would be largely similar to said plates described for the first embodiment. As the radial expansion of the tubing under pressure would necessarily involve a significant change in the volume of the inner hollow of the tubing the increased volume of liquid under pressure can be provided by the same means as was described for version one of this embodiment.

The fourth version of this embodiment (FIG. 4a) will comprise a liquid filled hollow tubing which will be shaped according to the type of spring such as for example coiled spring, with both ends of it hermetically sealed and an appropriately sized piece of a material able to change its volume when voltage is applied, such as for example a suitable kind of electro-active polymer is installed (15a) between electrodes (16a) mounted on the cap (17a) in the tubing's hollow together with the wiring to apply the said voltage. The advantage of this version of this embodiment is its simplicity and accordingly the lower cost of manufacturing such springs.

The fifth version of this embodiment will be similar to the first version of this embodiment featuring the use of either a membrane or a piston, but instead of a liquid the hollow tubing will be filled with lubricated balls of a predetermined and sufficiently small relatively to the diameter/size of tubing's hollow so that this ball filling of the hollow will behave similarly to the incompressible liquid when pressured by the membrane or piston. The inner surface of tubing's hollow would usually be provided with low friction surface or coating. The advantage of this version is that there is no possibility of liquid's leakage at high pressures and accordingly the ends of the spring's tubing can be less than hermetically closed which is cheaper to produce.

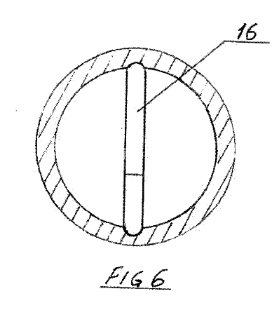

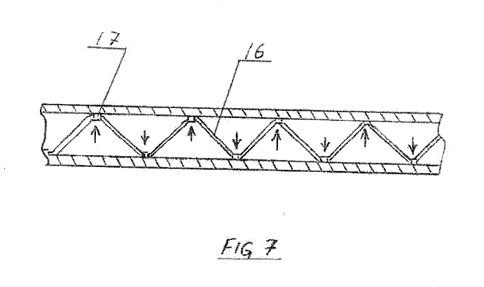

In the third embodiment of the present invention the hollow tubing's shape (FIG. 6) will be flexed into a different form by the action (such as push) from the inside of the active element(s); such as smart memory alloy wires (16) with (FIG. 7) abrasion prevention pads on them (17) (which will be shorter on the side of the tubing where the increase in tensile stress concentration is desirable and substantially longer on the opposite side of the tubing to minimize the said stress concentration where it is not desirable) or the electro-active polymer strip stacks etc inserted into the tubes length, possibly into the grooves on the inner surface of the tubing walls (which can be produced during the extrusion process). The straight tubes of this embodiment can be used in leaf strings by installing them in suitable flat housing which is appropriately stiff and flexible. The coiled tubes of this embodiment can be used in helical springs.

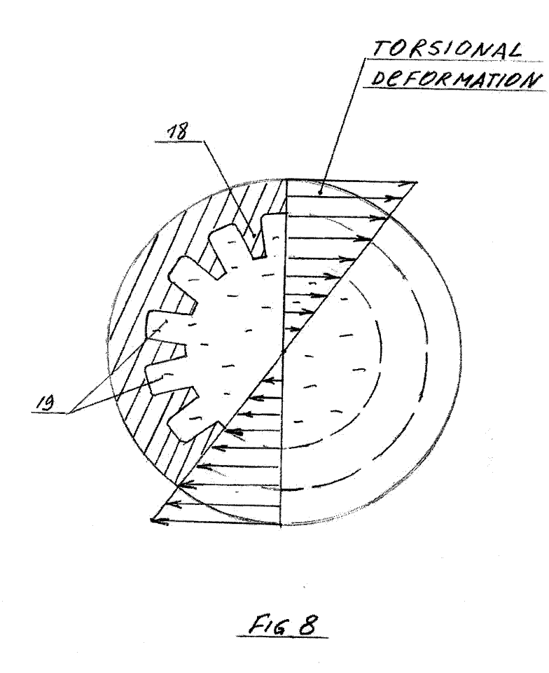

The spring of the fourth embodiment will be similar to the springs of the second embodiment, but with a different cross-sectional shape, namely the kind of cross-sectional shape that will deform, when subjected to torsional stress present in the helical springs being loaded, changing the area of the tubing's cross-section inner hollow and thus the total inside volume and accordingly the inside pressure. One such cross-sectional shape (FIG. 8) will be comprising the ridges (18) separated by the grooves (19). Said grooves will have rounded edges at the bottoms to prevent the concentration of stress. As the changes in inner volume are expected, to prevent the tubing's diameter excessive outward expansion and the spring's excessive stiffening, the hollow of the tubing may be filled with a compressible liquid. This embodiment can also be implemented similarly to the second version of the second embodiment comprising the filling with the high thermal expansion coefficient and an electric heating element, but this version of fourth embodiment will lack the inherent ability to measure the springs linear compression or expansion without an additional inside pressure sensor. The purpose of the above-described changes in comparison to the second embodiment is to provide the spring with the limited actuation ability and with the ability to act as a sensor measuring the load acting on it and its deformation and providing an electric signal to the control system corresponding to the amount of force and deformation. These electrical signals will be generated by the piezo-electric crystal actuators installed in ways similar to what was described for the second embodiment or by electro-active polymers with piezo-electric properties also installed as described for the second embodiment or the actuators comprising said polymers.

The spring of the fifth embodiment will be similar to the third version of the second embodiment but with one major difference. In said version of the second embodiment the outline of the cross-section of the tubing had relief parts forming ridges extending lengthwise along the tubing while being parallel to its central axis, with convex parts being adjacent to said ridges and separating them from each other.

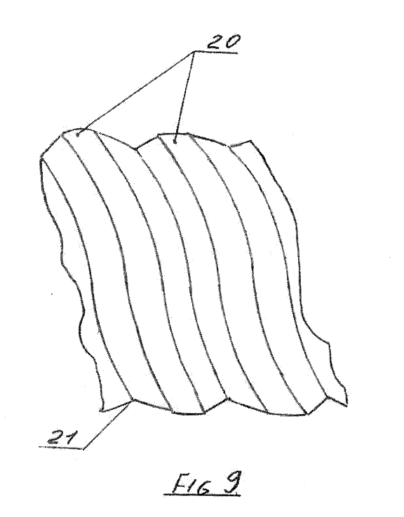

The spring of the fifth embodiment (FIG. 9) will also have ridges with convex channels between them, but this whole structure of ridges (20) and channels (21) comprising the surface of the tubing will have a twist relative to the tubing's axis. Said twist will be helical, can be directed either clockwise or counter-clockwise and the ridges will resemble threads with predetermined pitch angle. As the operation of the spring of this embodiment is expected to involve a substantial change in the tubing's inner hollow volume, that necessitates placing a larger membrane or diaphragm of predetermined size outside of the spring's tubing while connected to it, for example by a piece of a tubing or hose coming out of the sealed end of tubing or from a hole made on the side of the end coil etc, and either inside or outside of the spring perimeter or connecting as described above the spring to a hydraulic high pressure line or circuit.

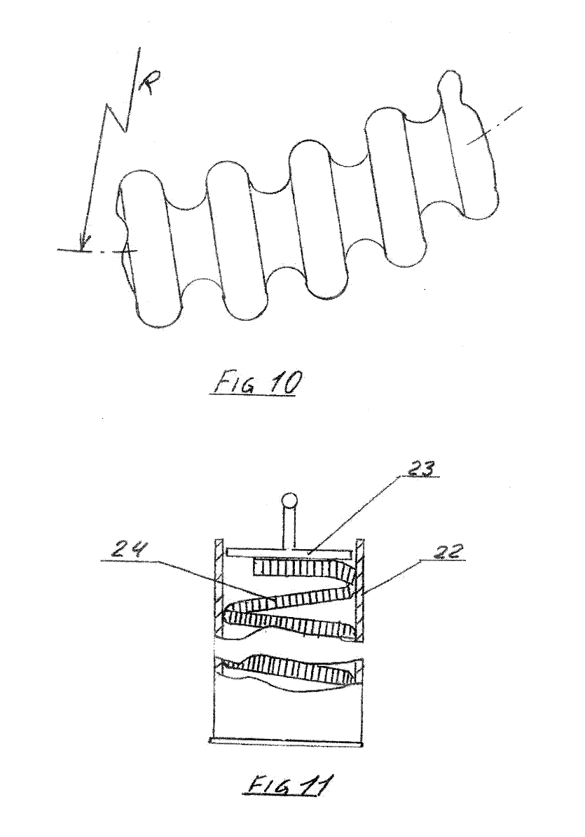

In the sixth embodiment the coiled springs of the present invention will comprise hollow tubing (FIG. 10) which will have the structure resembling that of the annular corrugated hoses or that of metal bellows actuators, but with the predetermined wall thickness and material type which is appropriate for the loads that it is designed to bear including the actuated piston installed at least at one end of the spring's tubing is possible where limited variability in stiffness is required, in most cases external sources providing high pressure liquid input/output in larger volume will be similar to what was described for version one of the second embodiment. For the springs of this embodiment the end coils can be made flat and placed onto the conical centering bases (not shown) or onto other centering bases of suitable shapes which would allow the end coils to change their diameter. The end coils can also be provided with padding (not shown) and lubrication protecting the end coils from wearing out when their diameters are expanding or contracting. The springs of this embodiment will generally be changing their stiffness slower than the springs of other embodiments, but are expected to vary the stiffness by several times depending on their specific design and operating parameters.

The spring of the seventh embodiment of the present invention (FIG. 11) will comprise coiled hollow tubing similar (24) to that of the sixth embodiment, which will be enclosed into a retaining cylinder (22) with a piston-like cover (23) (with lubricated inside surface) of the end coil of the tubing, said retaining cylinder will generally have a low friction coating and/or will be lubricated inside in order to prevent the coils from expanding in diameter with the increase in pressure, as was the case in sixth embodiment, but instead to force the expanding lengthwise tubing to form new coils inside said retaining cylinder. The spring of this embodiment will have the actuation capability in addition to the stiffness variability.

It should be noted that some of these embodiments can be combined; for example the elastic beam of the first embodiment can be made of hollow tubing and combined with the inside pressure changing as implemented in the second embodiment. That combined embodiment would be particularly suitable for implementing a large decrease or increase in the beam's stiffness while at the same time suppressing the vibration by means of changing the pressure inside the hollow of said elastic beam and accordingly its stiffness with the required for that purpose frequency and phase. In another example the turnable elastic beam(s) of the first embodiment could also be made hollow and have the shape changing element exerting force from the inside of the hollow tubing as is implemented in the third embodiment. Other embodiments combinations are possible. The hollow tubing springs with constantly elevated pressure inside compared to the atmospheric pressure, can be made thin walled, as that term is defined for the pressure vessels. The elevated inside pressure will enhance such springs structural stability and prevention of crimping. Thin walled tubing springs is the implementation of the hollow tubing springs generally likely to be more responsive to the inside pressure variation than the thick walled hollow tubing springs of the same embodiment.

For the appropriate versions of the second, as well as fourth and fifth embodiments depending on the shape of the cross-section of the tubing's hollow and potentially a large deformation of the spring there is a possibility of the internal pressure reaching excessive levels which may cause the leakage from the sealed ends of the spring and cause other damage. If that degree of the pressure increase is to be expected for a given spring design then it makes sense to limit the excessive rise in the internal pressure by for example using a compressible liquid to fill the tubing's hollow. One suspended compressible polymer particles can be used. Still another solution to this problem will be by means of using the compressible inserts inside the tubing hollow in combination with the incompressible liquid or to use the overflow vessel for the oil or another incompressible liquid, possibly containing pressurized air or gas above the surface of the liquid in said vessel.

For the suppression of vibration the coiled springs of the second embodiment of first, third and fourth versions and of fourth and fifth embodiments supporting a load subjected to vibration can be used, by means of changing their stiffness with the same frequency as the incoming vibration but preferably with the opposite phase, thereby cancelling out the incoming vibration. The control system can be used for measuring the frequency and amplitude of the incoming vibration and activating the spring's actuators for changing the spring's stiffness with the same frequency and with degree of change in stiffness, and preferably degree of spring's contraction or expansion (actuation), corresponding to the amplitude of the incoming vibration.

For the second, fourth and fifth embodiments in order to assure that there is no coil size expansion that will reduce the stiffness, when the internal pressure is applied the following confining means are proposed. One way is to use an external retaining cylinder with an inside diameter just sufficient for allowing the spring inside of said cylinder to slidably expand or contract without said spring's coil diameter expanding. The inside walls of said cylinder would generally be lubricated and/or have low friction coating. Alternatively a jacket made of wire mesh which would not allow the spring coil diameter to expand by means of having suitably strong hoops made for example of carbon fiber etc extending around the spring generally perpendicularly to its axis while said hoops are connected along the spring's axis by wires or strings or threads of such properties and structure which are suitable for allowing the spring axial expansion or contraction by means of said jacket expanding or contracting with the spring. A third way to accomplish this objective of preventing the spring coils from expanding will be by using cross-ties affixed at diametrically opposing points of each coil.

For the coiled springs of second, fourth, fifth and seventh embodiments, especially for the plastic springs, there is a possibility at high pressure levels of the significant hollow tubing external diameter expansion. In that case, if the confining means, such as a retaining cylinder, are used, said tubing's external diameter expansion will cause the tubing's centerline to shift radially inward thereby making the coil diameter smaller and because of that the spring stiffness higher—thus it is another factor that will contribute to stiffness variability.

When a plurality of the springs of the present invention are used in combination supporting a single load, such as for example supporting a truck or a railroad car they can be used, by means of lessening of the stiffness on the side of the load facing the inner side of the road/rail curve while increasing it on the other side, to prevent said load from inclining towards the outer side of the road/rail curve which can the cause the vehicle to overturn or the freight inside to shift. Besides the load redistribution prevention, it would be possible to also implement load redistribution when it is desirable to shift weight to or from wheel(s) where that would be beneficial in connection with the operation of the automotive traction control system. The vehicle control system when a vehicle is traversing a curve or when the need for it is determined by the traction control system. The springs of the fourth and seventh embodiments having limited actuation capability may be particularly well suited for these applications.

### 6. SKETCHES AND DIAGRAMS

Drawings and Diagrams provided separately.

### 7. OPERATION

In operation the springs of the first embodiment will have their stiffness changed dynamically by means of turning (FIG. 2) the beams (1) by either, the turn actuators individually or possibly connected by chain/toothed belt to a plurality of beams or by linear actuators with links (3) or toothed racks generally operatively connected to a plurality of beams, with the required angular velocity and angle value or with a variable by the control system velocity and angle value according to a required mathematical function/formula so that at any time the beams pertinent area moment of inertia is as needed to provide the required stiffness. For other applications the spring beams' (1) angular position may be changed as needed when needed by the actuators activated by the control system or the operator command or said angular positions can possibly be changed manually and locked in that position by known locking means until another change in stiffness is required. For the leaf springs provided with contact surfaces and the thin layer of electro-rheological fluid (hereinafter ERF) between them, the application of adjustable voltage can harden the fluid to a desirable degree to the point of rigidity thereby controlling the friction between the spring plates and controlling the spring performance and suppressing oscillations and vibration.

For the torsion spring implementation of this embodiment (FIG. 3) to change the stiffness the control ring (6) will be turned by the link (7) connected to the linear actuator. When turning the toothed inner side of the control ring will turn the gears (8) at the bases of the elastic beams (4) thereby also turning the beams themselves. The highest stiffness for the torsion spring will be when the said beams are tangential to the control ring (6) and the lowest when they are turned in line with the radius of the control ring.

For the second embodiment the control system will operate the linear actuator pushing the flexible membrane more or less into the hollow of the spring tubing. As there are no air pockets and the liquid is incompressible the push of the membrane into the said hollow will immediately produce a large increase in the hydrostatic pressure, while the backward motion of the membrane will produce a drop in the hydrostatic pressure. The pressure spike (drop) will practically instantly spread along the whole length of the tubing's hollow and will increase the tensile stresses in the tubing walls. At the same time, depending on the hollow tubing's relationship of the internal and external diameters, the pressure applied and the material of the tubing, the spring's tubing may significantly expand radially—which is especially true for the springs of version three of this embodiment designed for that expansion. Thereby the spring will be pre-tensioned similarly to what happens with an inflated hose—it will stiffen and will be harder to flex or to deform torsionally. As the actuation time of a smart memory alloy (hereinafter SMA) actuator is about 0.1 sec. whereas the actuation time of the piezo-electric produce the hardening and relaxation of the springs with practically any required frequency which would be useful for counteracting vibration. Of course the control system will also be able to do the reset of the springs stiffness for an extended period of time. The second version of this embodiment is cheaper and simpler, it is suitable for changing the stiffness of the spring for an extended period of time by means of heating the wax filling by activating an electric heating element which will produce a very significant rise in the pressure inside the tubing's hollow and thus a rise in the tensile stress in the tubing's walls which will decrease slowly once the heating is stopped due to wax's cooling and the resulting decrease in pressure. It should also be noted that for the thinner-walled springs or springs made of more expandable materials such as plastic springs the increase in pressure will also produce a significant expansion of the hollow tubing's diameter, thus resulting in its cross-section's polar moment of inertia increase causing the torsional stiffness of the spring tubing to further increase. Likewise due to said expansion in diameter, the tubing's cross-section area moment of inertia will also increase, thereby further enhancing the increase in tubing's bending stiffness which is useful for employing the straight hollow tubing elastic elements, as per this embodiment of this invention, in leaf springs.

The operation of the third version of the second embodiment of the spring of this invention is adequately described in the Description section and will not be re-iterated here, but is included herein by way of reference, as if fully set forth.

The fourth version of the spring of this embodiment (FIG. 4a) the appropriate level of voltage will be applied to an insert (15a), made of suitable electro-active polymer, which will cause it to expand increasing its volume by a predetermined amount and that will cause a large predetermined increase in pressure inside the tubing's hollow. That pressure increase will cause the stiffness increase in the same way as was described for the versions one and three of this embodiment. When the voltage is reduced or removed the said polymer insert will contract by a predetermined amount, the pressure inside the tubing's hollow will decrease by a predetermined amount and the stiffness of the spring will be reduced also by a predetermined amount.

The operation of the fifth version of the second embodiment of the spring of this invention is adequately described in the Description section and will not be re-iterated here, but is included herein by way of reference, as if fully set forth.

For the third embodiment the control system or the operator by turning on the electric power to the spring will initiate the active elements movement inside the tubing's hollow and thus the flexing of the tubing's shape from the inside either to increase or to decrease its cross-section's area moment of inertia which is a known major factor affecting the flexing stiffness (relevant for the leaf springs) and/or said cross-section's polar moment of inertia which is a known major factor affecting the torsional stiffness (relevant for coil springs and torsions) while also increasing or decreasing the tensile stresses in the tubing's walls. Both of the said factors' increase or decrease will accordingly produce the changes in stiffness of the spring. As two contributing factors are involved the amount of stiffness change occurring is likely to be substantial.

For the fourth embodiment the torsional deformation (FIG. 8) of the hollow tubing's pronounced the greater is the radial distance from the cross-section's center.

Accordingly the geometry of the cross-section subject to said deformation will become distorted and the cross-sectional area of the channels (19) will change and thus the volumes inside said channels will also change, as will the overall volume of the tubing's inner hollow. The volume changeability due to the torsional deformation will also likely occur for the tubing as described for the third version of the second embodiment and for the tubing as described for the fifth embodiment and likely for the broad variety of tubing types with non-circular cross-sections such as oval, elliptic etc and therefore those types of tubing may be suitable to be used in the springs of this embodiment. This changeability of volume will allow by means of varying the inside pressure not only to counteract the deformation of the spring caused by its load thereby increasing its stiffness, but may also be used to vary the length of the spring thereby providing it with the actuation capability which can be used for example to vary vehicle's clearance between its bottom and the road/terrain surface while also changing its suspension's stiffness and possibly counteracting its suspension vibrations and oscillations thereby eliminating or lessening the need for the shock absorber. Said volume variability leading to the inside pressure variability can also be used for measuring the pressure and therefore the loading force causing it to change, if the actuator connected to the membrane or a piston has piezo-electric quality and is inactive at the moment of such measurement or there is an electro-active polymer insert inside the spring with piezo-electric qualities (which is inactive at the moment of measurement) as was described for version four of the second embodiment and could be used in this embodiment as well. It should be noted that with large deformation (compression or extension) of the spring significant changes in the internal volume may be produced thereby possibly producing large pressure increases however when the means of mitigating such large pressure increase are employed as described in the Description section including the compressible liquids or the overflow vessel or the compressible insert(s).

For the fifth embodiment the tubing (FIG. 9), when subjected to the increase in pressure will begin to expand radially, but said tubing's cross-section will also begin to turn in the direction opposite to the direction of its ridges (20) twist. When that turning movement is coinciding with the direction of the torsional deformation resulting from the spring's loading then said torsional deformation will be promoted and the spring's stiffness will decrease. When it is in the opposite direction to the torsional deformation resulting from the spring's loading then the spring will be dynamically stiffened.

For the sixth embodiment the corrugated tubing is designed to expand lengthwise when the inside pressure is applied thus increasing the spring coils diameter. Spring coil diameter is a major factor determining the stiffness of a spring and with its increase the stiffness will very substantially decrease despite the much smaller effects promoting the stiffness increase as in the other embodiments due to the increased pressure inside. The springs of this embodiment resemble bellows actuators whose length at full stroke expansion may increase by up to 90%. Therefore a comparable increase in the length of the tubing of this embodiment can be justifiably expected causing the spring's stiffness variability by several times. The conical or other suitable centering bases will keep these springs centered while their diameter changes.

The spring's of the seventh embodiment (FIG. 11) tubing is similar to the tubing of the sixth embodiment and will also expand lengthwise as the inside pressure is increased, but the retaining cylinder (22) will prevent the tubing (24) radial expansion instead forcing it to form new coils of the same constant diameter as it expands. Therefore the length of the spring will expand and thus it is provided with the actuation capability and the stiffness variability.

What claimed is:

1. A spring made of hollow tubing filled with a liquid and provided with the means of varying the hydrostatic pressure in said liquid in order to vary said spring's stiffness.

2. A spring of claim 1 where said means of varying the hydrostatic pressure is a membrane operatively connected with an actuator and positioned to press on said liquid.

3. A spring of claim 1 where said means of varying the hydrostatic pressure is a piston operatively connected with an actuator and positioned to press on said liquid.

4. A spring of claim 1 where said means of varying the hydrostatic pressure is an electric heating cord immersed in said liquid and varying its temperature in order to vary said liquid's thermal expansion thereby varying the hydrostatic pressure in order to vary the spring's stiffness.

5. A spring of claim 1 where said means of varying the hydrostatic pressure is an insert into said tubing's hollow which changes its volume depending on the voltage applied to it thereby varying the hydrostatic pressure in order to vary the spring's stiffness.

6. A spring of claim 1 where the cross-section of the spring's tubing deforms when a load is applied to the spring, in a way to cause said cross-sectional area and by extension the inside volume of the spring's hollow to change which enables the spring to expand or contract when the volume of liquid inside of it is changed thereby providing it with actuation capabilities.

7. A spring of claim 6 that uses said actuators which are of piezo-electric type, able to produce electric signals when hydro-static pressure changes, with said signals strength corresponding to the hydro-static pressure and reflecting the amount of spring's deformation and therefore also the amount of load acting on it, thereby measuring said load.

8. A spring of claim 1 where the outline of the cross-section of said spring comprises convex parts to enable the cross-section to expand radially.

9. A spring of claim 2 where the outline of the cross-section also contains concave parts forming helical thread-like shapes on the surface of said tubing wherein said thread-like shapes expand with the increase in inside pressure causing the tubing's cross-section to turn and thereby varying the spring's stiffness.

10. A spring of claim 1 comprising annular corrugated hollow tubing whose length will vary depending on the pressure inside of the hollow with said varying of the tubing's length resulting in the varying of the spring coil diameter which in turn varies the springs stiffness.

11. A spring of claim 10 wherein said annular corrugated tubing is coiled inside a retaining cylinder in order to force the tubing to vary the number of coils when the pressure inside of it varies there by providing the spring with the actuation ability to vary its length as well as its stiffness.

12. A leaf spring comprising at least one housing plate which comprises at least one turnable elastic beam whose cross-section's area moment of inertia is different relative to the horizontal and vertical axis wherein by turning of said beam its stiffness can be varied relative to the horizontal axis of the cross-section and thereby the housing plate's stiffness is varied and the stiffness of the whole leaf spring is varied.

13. A leaf spring of claim 12 comprising thin layer of electro-rheological fluid between at least to of its plates with said layer varying its viscosity when the voltage is applied to it thereby varying the friction forces between plates and as a result the spring's stiffness.

14. A spring made of hollow tubing and comprising inserted into the tubing along its length electrically activated cross-section shape changing means in order to change the cross-sectional shape and as a consequence the spring's stiffness.

15. A spring of claim 14 wherein said cross-section shape changing means is a smart memory alloy insert able to vary its height inside the tubing with sufficient force to deform it in a predetermined way in order to vary the tubing's stiffness.

16. A spring of claim 14 wherein said cross-section shape changing means is an electro-active polymer insert able to vary its height inside the tubing with sufficient force to deform it in a predetermined way in order to vary the tubing's stiffness.
